(19) United States
(12) Patent Application Publication
(10) Pub. No.: US 2025/0316793 A1
(43) Pub. Date: Oct. 9, 2025

(54) BATTERY SYSTEM

(71) Applicant: Caterpillar Inc., Peoria, IL (US)

(72) Inventor: Joe Alexander York-Fisher, Liden (GB)

(73) Assignee: Caterpillar Inc., Peoria, IL (US)

(21) Appl. No.: 18/627,640

(22) Filed: Apr. 5, 2024

(51) Int. Cl. H01M 10/659; H01M 10/653; H01M 50/209; H01M 50/211; H01M 50/502

(52) U.S. Cl. CPC H01M 10/659; H01M 10/653; H01M 50/209; H01M 50/211; H01M 50/502

(57) ABSTRACT

A battery system includes a housing defining a plurality of walls. The battery system also includes a plurality of battery cells disposed in the housing. Each battery cell from the plurality of battery cells is spaced apart from an adjacent battery cell by a gap. Each of the plurality of battery cells includes any one of a prismatic battery cell and a pouch type battery cell. The battery system further includes at least one electric connection assembly connected to the plurality of battery cells. The battery system includes a phase-changing material disposed within the housing, such that the phase-changing material is in thermal contact with each of the plurality of battery cells and is isolated from the at least one electric connection assembly. The phase-changing material is configured to expand when subjected to heat.

### TECHNICAL FIELD

The present disclosure relates to a battery system and a method of assembling the battery system.

### BACKGROUND

Battery systems are used in a variety of applications as a means of power supply. For example, battery systems are being increasingly implemented in passenger vehicles, construction machines, energy storage systems, and the like, to provide power supply.

Generally, battery systems include a number of battery cells to store electrical power and distribute the stored electrical power. The battery cells may include prismatic battery cells or pouch type battery cells, for example. Such battery cells may be suspended within a casing and contacts an outer surface of the casing via a number of tab connectors that may lead to thermally insulative air gaps between the battery cells and the outer surface of the casing.

Further, the battery systems are prone to temperature gradients formed between the tab connectors and central parts of the battery cells. The temperature gradients may reduce a performance and a lifetime of the battery cells due to imbalanced degradation mechanisms that may lead to thermal runaway in the battery system. In order to prevent the thermal runaway in the battery system, external thermal management methods may be applied to the casing. However, an effectiveness of the thermal management methods may reduce as heat transfer via a tabular conduction path is greater than a poor radial conduction via internal air flow within the casing.

Thus, a solution is required to address the issue of uneven temperature gradients within the battery system in order to improve a thermal management of the battery system.

U.S. Pat. No. 8,927,131 describes a battery module with microencapsulated phase change materials as an automotive thermal management system. In one form, the microencapsulated phase change material is in the form of a foam made of a core encased in a generally polymer-based shell. In a more particular form, the foamed material may be tailored to go through isothermal phase change at more than one temperature, such as a relatively cold temperature and a relatively high temperature. A thermal management system based on the use of such microencapsulated phase change material includes heating and cooling capabilities for conditions expected to be encountered under both high-temperature and low-temperature vehicular operating conditions. Methods of controlling the temperature in battery modules are also described.

### SUMMARY OF THE DISCLOSURE

In an aspect of the present disclosure, a battery system is provided. The battery system includes a housing defining a plurality of walls. The battery system also includes a plurality of battery cells disposed in the housing. Each battery cell from the plurality of battery cells is spaced apart from an adjacent battery cell by a gap. Each of the plurality of battery cells includes any one of a prismatic battery cell and a pouch type battery cell. The battery system further includes at least one electric connection assembly connected to the plurality of battery cells. The battery system includes a phase-changing material disposed within the housing, such that the phase-changing material is in thermal contact with each of the plurality of battery cells and is isolated from the at least one electric connection assembly. The phase-changing material is configured to expand when subjected to heat.

In another aspect of the present disclosure, a method of assembling a battery system is provided. The method includes providing a housing defining a plurality of walls. The method also includes inserting a plurality of battery cells in the housing. Each battery cell from the plurality of battery cells is spaced apart from an adjacent battery cell by a gap. Each of the plurality of battery cells includes any one of a prismatic battery cell and a pouch type battery cell. The method further includes connecting at least one electric connection assembly to the plurality of battery cells. The method includes disposing a phase-changing material within the housing, such that the phase-changing material is in thermal contact with each of the plurality of battery cells and is isolated from the at least one electric connection assembly. The phase-changing material is configured to expand when subjected to heat.

Other features and aspects of this disclosure will be apparent from the following description and the accompanying drawings.

### BRIEF DESCRIPTION OF THE DRAWINGS

FIG. 1 is a schematic view of a battery system, according to an example of the present disclosure;

FIG. 2 is a schematic view of a battery system, according to another example of the present disclosure; and

FIG. 3 is a flowchart for a method of assembling the battery system of FIGS. 1 and 2, according to an example of the present disclosure.

### DETAILED DESCRIPTION

Wherever possible, the same reference numbers will be used throughout the drawings to refer to the same or like parts.

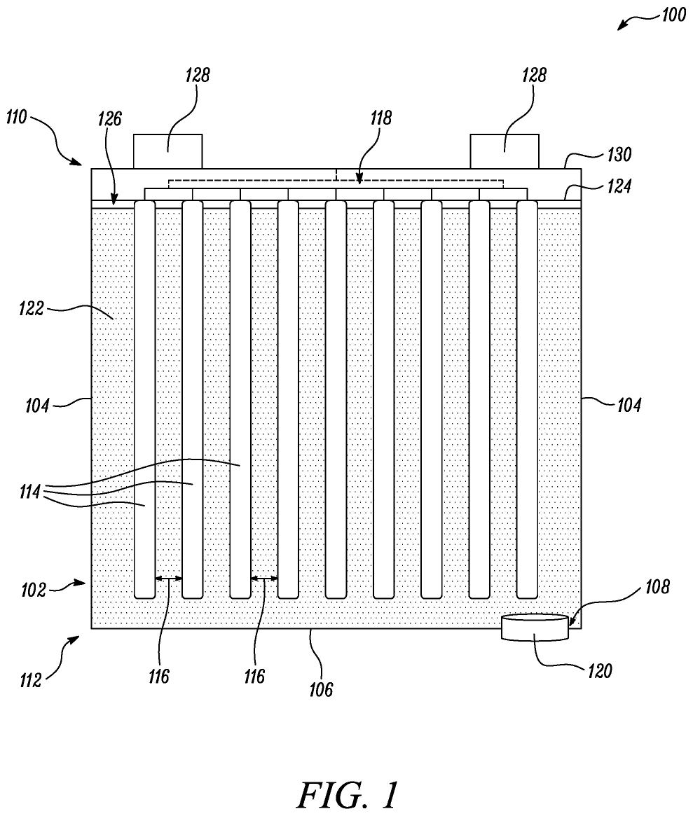

Referring to FIG. 1, a schematic view of an exemplary battery system 100 is illustrated. The battery system 100 may supply electrical power to a machine. The machine may include a moving machine or a stationary machine. In some examples, the machine may be a work/construction machine, for example. The machine may alternatively include an energy storage system.

The battery system 100 includes a housing 102 defining a number of walls 104. In some examples, the battery system 100, or components thereof, such as the housing 102, may be made of aluminum, composites, plastics, and/or any other suitable material. As such, although one battery system 100 is shown in FIG. 1, multiple such battery systems may be electrically coupled together. For example, multiple battery systems may be electrically coupled to one another to provide a desired power output and voltage output.

The housing 102 includes a cover 130 coupled to each of the number of walls 104. The housing 102 also includes a base 106 coupled to each of the number of walls 104. The housing 102 defines a top end 110 and a bottom end 112 opposite the top end 110. The cover 130 is disposed proximal to the top end 110 of the housing 102 and the base 106 is disposed proximal to the bottom end 112 of the housing 102. Further, the housing defines an opening 108. In the illustrated example of FIG. 1, the base 106 of the housing 102 defines the opening 108. Alternatively, the opening 108 may be defined in one of the walls 104. The cover 130, the walls 104, and the base 106 together form a sealed structure of the housing 102. In the illustrated example of FIG. 1, the housing 102 has a square shape. In other examples, the housing 102 may have a rectangular shape or any other shape, based on application attributes.

The battery system 100 also includes a sealing element 120 to seal the opening 108 in the base 106. The sealing element 120 may be made of any material, such as, a composite, a polymer, a rubber, and/or combinations thereof. The sealing element 120 may form a substantially fluid-tight seal with the base 106 to prevent leakage of materials therethrough.

The battery system 100 further includes a number of battery cells 114 disposed in the housing 102. Each battery cell 114 from the number of battery cells 114 is spaced apart from an adjacent battery cell 114 by a gap 116. Each of the number of battery cells 114 includes a prismatic battery cell or a pouch type battery cell. The prismatic battery cell may include a square-case battery cell, a blade-shaped battery cell, a polygonal-prismatic battery cell, such as, a hexagonal-prismatic battery cell, etc., without any limitations.

Further, the pouch type battery cell may include a cell stack contained within a flexible enclosure. Based on different disposition manners of electrode plates, the pouch type battery cell or the prismatic battery cell may be a laminated battery or a wound battery. It should be noted that the present disclosure is not limited by a construction of the prismatic battery cell or the pouch type battery cell, and the prismatic battery cell or the pouch type battery cell may include any design/construction known in the art.

The number of battery cells 114 may incorporate, for example, a lithium-ion battery technology to store electrical power and distribute the stored electrical power at a desired battery system voltage and a desired battery system amperage. It should be noted that the power distribution and power storage characteristics of the battery system 100 may be defined at least in part on the configurations of the number of battery cells 114 included in the battery system 100. In other examples, the battery system 100 may embody any other type of battery technology, as per requirements. Further, the battery cells 114 may include any capacity, voltage, energy, etc.

The battery system 100 includes one or more electric connection assemblies 118 connected to the number of battery cells 114. Particularly, in the illustrated example of FIG. 1, the one or more electric connection assemblies 118 is a first electric connection assembly 118 that is disposed proximate to the top end 110 of the housing 102. The first electric connection assembly 118 may be interchangeably referred to as the “electric connection assembly 118”. The one or more electric connection assemblies 118 are disposed inside the housing 102 of the battery system 100. The one or more electric connection assemblies 118 may connect the number of battery cells 114 in a series configuration, a parallel configuration, or a combination thereof. In some examples, the one or more electric connection assemblies 118 may include a number of internal tab connectors that electrically connect the battery cells 114.

The battery system 100 also includes one or more external tab connectors 128. The external tab connectors 128 are disposed at the top end 110 of the housing 102 and may be coupled with the cover 130. The external tab connectors 128 are electrically connected with the first electric connection assembly 118. The battery system 100 may distribute the stored electrical power via the external tab connectors 128. In the illustrated example of FIG. 1, a pair of the external tab connectors 128 are illustrated. One external tab connector 128 may be connected to a positive electrode of the battery system 100 and another external tab connector 128 may be connected to a negative electrode of the battery system 100. It should be noted that the first electric connection assembly 118 and the external tab connectors 128 may be disposed at the bottom end 112 or along the walls 104, without any limitations.

The battery system 100 further includes a phase-changing material 122 disposed within the housing 102, such that the phase-changing material 122 is in thermal contact with each of the number of battery cells 114 and is isolated from the one or more electric connection assemblies 118. In other words, the phase-changing material 122 is separated from the first electric connection assembly 118 to prevent any contact therebetween. The phase-changing material 122 expands when subjected to heat. In some examples, the phase-changing material 122 may have an expansion coefficient in a range of 12% to 18%, for example.

It should be noted that the phase-changing material 122 refers to a material that releases/absorbs sufficient energy during phase transition to provide heat or cooling. The phase transition is typically between a solid state and a liquid state.

The phase-changing material 122 is disposed between the wall 104 from the number of walls 104 of the housing 102 and the battery cell 114 from the number of battery cells 114 that is disposed adjacent to the wall 104. Specifically, the phase-changing material 122 is disposed between each wall 104 and a corresponding battery cell 114 that is disposed to the wall 104. Further, the phase-changing material 122 is disposed within the gap 116 defined between two adjacently disposed battery cells 114. Specifically, the phase-changing material 122 is disposed within the gap 116 defined between each pair of adjacently disposed battery cells 114.

The phase-changing material 122 may include an inorganic phase-changing material, an organic phase-changing material, or a composite phase-changing material. The inorganic phase-changing material may include a crystalline hydrated salt, a molten salt, a metal, an alloy, and the like. The organic phase-changing material may include a paraffin wax, acetic acid, or any other organic material. In an example, the phase-changing material 122 is the paraffin wax. In some examples, the phase-changing material 122 may include antioxidants, such as, butylated hydroxytoluene (BHT). It should be noted that the present disclosure is not limited to a composition of the phase-changing material 122.

The phase-changing material 122 includes one or more additives to achieve a desired thermal conductivity and a desired melting point of the phase-changing material 122 based on an optimal working temperature of the number of battery cells 114. In some examples, the one or more additives includes a graphite material. However, the additives may include any other substance/material, without any limitations.

Further, the opening 108 facilitates filling or removal of the phase-changing material 122 from the housing 102. In an example, a user may remove the sealing element 120 to fill or remove the phase-changing material 122 from the housing 102. The sealing element 120 may be sealed after a refilling/removal operation is concluded. In an example, the phase-changing material 122 may be filled in the housing 102 in a molten state.

The battery system 100 further includes one or more separators 124 disposed within the housing 102. The one or more separators 124 are made of a metal or a polymer. The one or more separators 124 are disposed within the housing 102 such that a hollow space 126 is present between the phase-changing material 122 and the one or more separators 124 to accommodate expansion of the phase-changing material 122. The one or more separators 124 isolate the phase-changing material 122 from the electric connection assembly 118. Specifically, the one or more separators 124 is a first separator 124 disposed proximate to the top end 110 of the housing 102 to isolate the phase-changing material 122 from the first electric connection assembly 118. The separator 124 may be interchangeably referred to as the first separator 124. A design of the separator 124 may depend on a technique of assembling the battery system 100. Accordingly, the separator 124 may embody a continuous sheet or the separator 124 may include slots, for example. In one example, the slots may allow insertion or removal of the battery cells 114 from the housing 102. In another example, the separator 124 may include a composite construction. For example, the separator 124 may include a fixed slotted separator element that is preinstalled in the housing 102 to hold the phase-changing material 122, and another separator element may be attached to the battery cells 114 to connect up and seal the phase-changing material 122 from the first electric connection assembly 118. In an example, the first separator 124 may be made of a metal that separates the phase-changing material 122 from the one or more electric connection assemblies 118. In other examples, the first separator 124 may be made of a polymer. It should be noted that the present disclosure is not limited to a composition of the separator 124.

In an example, under heavy load conditions, an increase in current demand from the battery cells 114 may lead to heating of the battery cells 114. Since the phase-changing material 122 is in thermal contact with each battery cell 114, when the battery cells 114 are heated, the phase-changing material 122 also heats up and transitions from the solid state to the liquid state. A large amount of latent heat is absorbed by the phase-changing material 122 that causes expansion of the phase-changing material 122. The phase-changing material 122 may fill the hollow space 126 on expansion, while still being isolated from the electric connection assembly 118 and the external tab connectors 128, via the separator 124.

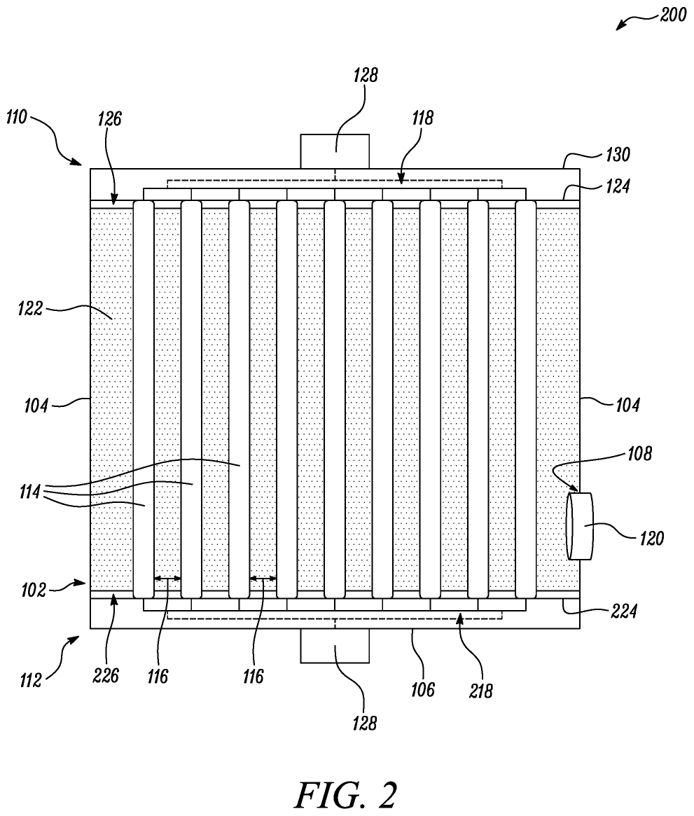

FIG. 2 is a schematic view of a battery system 200, according to another embodiment of the present disclosure. The battery system 200 is substantially similar to the battery system 100, with common components being referred to by the same numerals. In the illustrated example of FIG. 2, the wall 104 defines the opening 108 (instead of the base 106 as shown in FIG. 1). The battery system 200 includes the sealing element 120 to seal the opening 108 in the wall 104. The battery system 200 includes two external tab connectors 128. One external tab connector 128 is disposed at the top end 110 and the other external tab connector 128 is disposed at the bottom end 112. The battery system 200 includes the first electric connection assembly 118. The battery system 200 also includes a second electric connection assembly 218 that is disposed proximate to the bottom end 112 of the housing 102. The second electric connection assembly 218 may be electrically connected with the external tab connectors 128. The second electric connection assembly 218 is similar to the first electric connection assembly 118 described in relation to FIG. 1 in terms of functionality.

The battery system 200 further includes the first separator 124. The battery system 200 further includes a second separator 224 disposed proximate to the bottom end 112 of the housing 102 to isolate the phase-changing material 122 from the second electric connection assembly 218. The second separator 224 isolates the phase-changing material 122 from the second electric connection assembly 218. Specifically, the second separator 224 is disposed within the housing 102 such that a hollow space 226 is present between the phase-changing material 122 and the second separator 224 to accommodate expansion of the phase-changing material 122. A design of the second separator 224 may depend on a technique of assembling the battery system 200. Accordingly, the second separator 224 may embody a continuous sheet or the second separator 224 may include slots, for example. In one example, the slots may allow insertion or removal of the battery cells 114 from the housing 102. In another example, the second separator 224 may include a composite construction. For example, the second separator 224 may include a fixed slotted separator element that is preinstalled in the housing 102 to hold the phase-changing material 122, and another separator element may be attached to the battery cells 114 to connect up and seal the phase-changing material 122 from the second electric connection assembly 218. The second separator 224 is similar to the first separator 124 described in relation to FIG. 1 in terms of material and functionality.

In an example, under heavy load conditions, the increase in current demand from the battery cells 114 may lead to heating of the battery cells 114. Since the phase-changing material 122 is in thermal contact with each battery cell 114, when the battery cells 114 are heated, the phase-changing material 122 also heats up and transitions from the solid state to the liquid state. A large amount of latent heat is absorbed by the phase-changing material 122 that causes expansion of the phase-changing material 122. The phase-changing material 122 may fill the hollow space 126, 226 on expansion, while still being isolated from the first and second electric connection assemblies 118, 218 via the first and second separator 124, 224, respectively.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The battery system 100, 200 of the present disclosure includes the phase-changing material 122 disposed in thermal contact with each battery cell 114. The phase-changing material 122 expands when subjected to heat. Thus, the phase-changing material 122 may remove a radial element of thermal conduction.

Further, the phase-changing material 122 may include the additives that may help in achieving the desired thermal conductivity and the desired melting point of the phase-changing material 122 to match the optimal working temperature of individual battery cell chemistry.

When the battery cells 114 are hot, the phase-changing material 122 may melt and expands to fill the hollow space 126. The phase-changing material 122 may absorb latent heat and may provide a liquid medium to convect the heat from the battery cells 114. Incorporation of the phase-changing material 122 may reduce costs associated with an operation of a thermal management system of the battery system 100, 200 and may also improve an effectiveness of the thermal management system.

Further, when the battery cells 114 are cold, the phase-changing material 122 may solidify and may provide thermal insulation as well as minor impact protection to the battery cells 114 of the battery system 100, 200. In such a situation, the phase-changing material 122 may not conduct heat and electricity.

Further, the phase-changing material 122 may be robust, and may enhance a performance and a lifetime of the battery cells 114 and may prevent thermal runaway in the battery system 100, 200. The battery system 100, 200 described herein is simple in construction. Furthermore, the battery system 100, 200 may have less chances of failure and may not require high operator expertise for manufacturing/production. Moreover, the phase-changing material 122 may be added to existing battery designs with minimum modifications.

The battery system 100, 200 includes the opening 108 that may allow draining and filling of the phase-changing material 122. The opening 108 is sealed via the sealing element 120. The opening 108 may allow easy and quick draining or filling of the phase-changing material 122 without interfering with the arrangement of the battery cells 114.

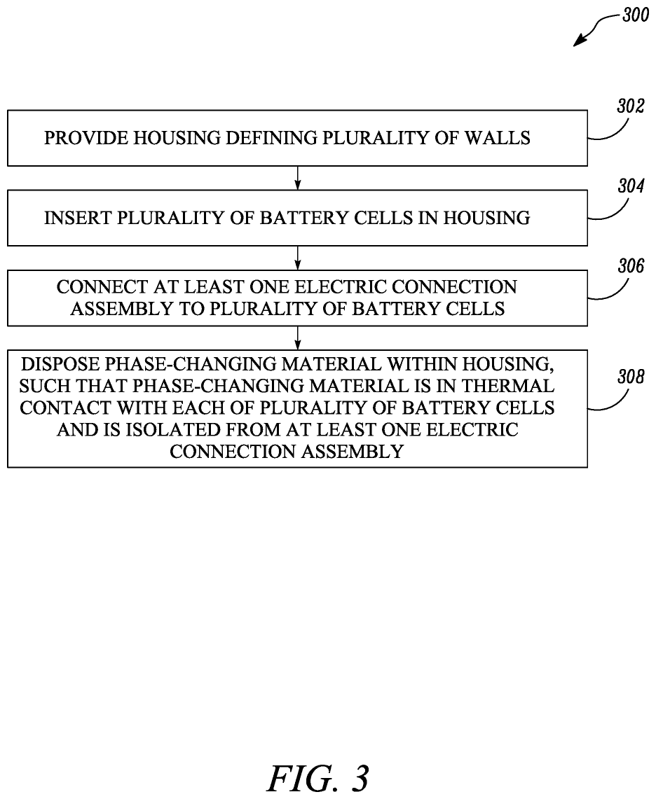

FIG. 3 is a flowchart for a method 300 of assembling the battery system 100, 200 of FIGS. 1 and 2. With reference to FIGS. 1 and 3, at step 302, the housing 102 defining the number of walls 104 is provided.

At step 304, the number of battery cells 114 are inserted in the housing 102. Each battery cell 114 from the number of battery cells 114 is spaced apart from the adjacent battery cell 114 by the gap 116. Each of the number of battery cells 114 includes the prismatic battery cell or the pouch type battery cell.

At step 306, the one or more electric connection assemblies 118 are connected to the number of battery cells 114. The one or more electric connection assembly 118 is the first electric connection assembly 118 that is disposed proximate to the top end 110 of the housing 102.

At step 308, the phase-changing material 122 is disposed within the housing 102, such that the phase-changing material 122 is in thermal contact with each of the number of battery cells 114 and is isolated from the one or more electric connection assemblies 118. The phase-changing material 122 expands when subjected to heat. The step 308 also includes disposing the phase-changing material 122 between the wall 104 from the number of walls 104 of the housing 102 and the battery cell 114 from the number of battery cells 114 that is disposed adjacent to the wall 104. The step 308 further includes disposing the phase-changing material 122 within the gap 116 defined between two adjacently disposed battery cells 114.

The housing 102 defines the opening 108. The method 300 includes filling or removing the phase-changing material 122 from the housing 102 via the opening 108 in the housing 102. The method 300 also includes sealing, by the sealing element 120, the opening 108 in the housing 102.

The method 300 further includes a step at which the one or more separators 124 are disposed within the housing 102. The one or more separators 124 isolate the phase-changing material 122 from the electric connection assembly 118. The step at which the one or more separators 124 are disposed within the housing 102 further includes providing the hollow space 126 between the phase-changing material 122 and the one or more separators 124 to accommodate expansion of the phase-changing material 122. The one or more separators 124 is the first separator 124 disposed proximate to the top end 110 of the housing 102 to isolate the phase-changing material 122 from the first electric connection assembly 118.

Referring to FIGS. 2 and 3, the method 300 further includes a step at which the second electric connection assembly 218 is connected with the number of battery cells 114. The second electric connection assembly 218 is disposed proximate to the bottom end 112 of the housing 102. The method 300 further includes a step at which the second separator 224 is disposed proximate to the bottom end 112 of the housing 102 to isolate the phase-changing material 122 from the second electric connection assembly 218.

It may be desirable to perform one or more of the steps disclosed in relation to method 300 in an order different from that depicted. For example, the battery cells 114 may be inserted into the housing 102 that already holds the phase-changing material 122 in molten form, which may simplify an assembly of the battery system 100, 200 from a mass production perspective. In such an example, the separators 124, 224 may either be pre-attached to the battery cells 114, or the separators 124, 224 may be pre-installed in the housing 102. In such examples, a design of the separators 124, 224 may be based on the method 300 used for assembling the battery system 100, 200. Further, the battery cells 114 may be inserted sideways, for example, through the walls 104 or the battery cells 114 may be lowered into the housing 102 via the top end 110. Furthermore, one or more of the steps disclosed in relation to method 300 may also be performed together.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

What is claimed is:

1. A battery system comprising:
a housing defining a plurality of walls;
a plurality of battery cells disposed in the housing, wherein each battery cell from the plurality of battery cells is spaced apart from an adjacent battery cell by a gap, and wherein each of the plurality of battery cells includes any one of a prismatic battery cell and a pouch type battery cell;
at least one electric connection assembly connected to the plurality of battery cells; and
a phase-changing material disposed within the housing, such that the phase-changing material is in thermal contact with each of the plurality of battery cells and is isolated from the at least one electric connection assembly, wherein the phase-changing material is configured to expand when subjected to heat.

2. The battery system of claim 1, wherein the housing defines an opening that facilitates at least one of filling and removal of the phase-changing material from the housing.

3. The battery system of claim 2 further comprising a sealing element adapted to seal the opening in the housing.

4. The battery system of claim 1, wherein the phase-changing material is disposed between a wall from the plurality of walls of the housing and a battery cell from the plurality of battery cells that is disposed adjacent to the wall.

5. The battery system of claim 1, wherein the phase-changing material is disposed within the gap defined between two adjacently disposed battery cells.

6. The battery system of claim 1, wherein the phase-changing material is a paraffin wax.

7. The battery system of claim 1, wherein the phase-changing material include at least one additive to achieve a desired thermal conductivity and a desired melting point of the phase-changing material based on an optimal working temperature of the plurality of battery cells.

8. The battery system of claim 7, wherein the at least one additive includes a graphite material.

9. The battery system of claim 1 further comprising at least one separator disposed within the housing, wherein the at least one separator isolates the phase-changing material from the electric connection assembly.

10. The battery system of claim 9, wherein the at least one separator is disposed within the housing such that a hollow space is present between the phase-changing material and the at least one separator to accommodate expansion of the phase-changing material.

11. The battery system of claim 9, wherein the at least one separator is made of any one of a metal and a polymer.

12. The battery system of claim 9, wherein the at least one electric connection assembly is a first electric connection assembly that is disposed proximate to a top end of the housing, and wherein the at least one separator is a first separator disposed proximate to the top end of the housing to isolate the phase-changing material from the first electric connection assembly, the battery system further comprising:
a second electric connection assembly that is disposed proximate to a bottom end of the housing; and
a second separator disposed proximate to the bottom end of the housing to isolate the phase-changing material from the second electric connection assembly.

13. A method of assembling a battery system, the method comprising:
providing a housing defining a plurality of walls;
inserting a plurality of battery cells in the housing, wherein each battery cell from the plurality of battery cells is spaced apart from an adjacent battery cell by a gap, and wherein each of the plurality of battery cells includes any one of a prismatic battery cell and a pouch type battery cell;
connecting at least one electric connection assembly to the plurality of battery cells; and
disposing a phase-changing material within the housing, such that the phase-changing material is in thermal contact with each of the plurality of battery cells and is isolated from the at least one electric connection assembly, wherein the phase-changing material is configured to expand when subjected to heat.

14. The method of claim 13, wherein the housing defines an opening, the method further comprising at least one of filling and removing the phase-changing material from the housing via the opening in the housing.

15. The method of claim 14 further comprising sealing, by a sealing element, the opening in the housing.

16. The method of claim 13, wherein the step of disposing the phase-changing material within the housing further includes disposing the phase-changing material between a wall from the plurality of walls of the housing and a battery cell from the plurality of battery cells that is disposed adjacent to the wall.

17. The method of claim 13, wherein the step of disposing the phase-changing material within the housing further includes disposing the phase-changing material within the gap defined between two adjacently disposed battery cells.

18. The method of claim 13 further comprising disposing at least one separator within the housing, wherein the at least one separator isolates the phase-changing material from the electric connection assembly.

19. The method of claim 18, wherein the step of disposing the at least one separator within the housing further includes providing a hollow space between the phase-changing material and the at least one separator to accommodate expansion of the phase-changing material.

20. The method of claim 18, wherein the at least one electric connection assembly is a first electric connection assembly that is disposed proximate to a top end of the housing, and wherein the at least one separator is a first separator disposed proximate to the top end of the housing to isolate the phase-changing material from the first electric connection assembly, the method further comprising:
connecting a second electric connection assembly with the plurality of battery cells, wherein the second electric connection assembly is disposed proximate to a bottom end of the housing; and
disposing a second separator proximate to the bottom end of the housing to isolate the phase-changing material from the second electric connection assembly.
